(19) United States
(12) Patent Application Publication
(10) Pub. No.: US 2025/0102973 A1
(43) Pub. Date: Mar. 27, 2025

(54) TRANSPORT DEVICE AND IMAGE FORMING APPARATUS

(71) Applicant: FUJIFILM Business Innovation Corp., Tokyo (JP)

(72) Inventors: Kenji KUGAYA, Kanagawa (JP); Keita HASHIMOTO, Kanagawa (JP); Haruka YASUDA, Kanagawa (JP)

(73) Assignee: FUJIFILM Business Innovation Corp., Tokyo (JP)

(21) Appl. No.: 18/587,149

(22) Filed: Feb. 26, 2024

(30) Foreign Application Priority Data
Sep. 27, 2023 (JP) 2023-166478

(51) Int. Cl. G03G 15/20

(52) U.S. Cl. CPC G03G 15/2028; G03G 15/2064

(57) ABSTRACT

A transport device includes: an endless first transporter configured to transport a medium; a second transporter facing the first transporter, and configured to transport the medium while nipping the medium between the first transporter and the second transporter; a first support that supports the first transporter; a second support that supports the first support and is movable relative to the first support; and a separator supported by the second support, and configured to separate the medium from the first transporter.

### CROSS-REFERENCE TO RELATED APPLICATIONS

This application is based on and claims priority under 35 USC 119 from Japanese Patent Application No. 2023-166478 filed Sep. 27, 2023.

### BACKGROUND

### (i) Technical Field

The present disclosure relates to a transport device and an image forming apparatus.

### (ii) Related Art

Japanese Unexamined Patent Application Publication Nos. 2020-134885 (“0039”-“0114” (in particular, “0039”-“0043”), FIGS. 3 to 9), 2008-292793 (“0016”-“0032”, FIGS. 1, 2, 4, and 6), and 08-286548 (“0019”-“0028”, FIGS. 1 and 3 to 6) describe technologies for separating a medium on a downstream side of a fixing device that fixes an unfixed image in an image forming apparatus.

Japanese Unexamined Patent Application Publication No. 2020-134885 describes a structure in which a separation sheet (108) is disposed on a downstream side of a fixing belt (101). The separation sheet (108) separates a recording material(S) from the fixing belt (101). The separation sheet (108) includes a separation member (108a) and a support member (108b). A positioner (108b-c-1) abuts against a fixing flange (104) to position the separation sheet (108) on the fixing flange (104).

Japanese Unexamined Patent Application Publication No. 2008-292793 describes a technology for separating paper (33) from a heating roller (1) by a separation guide (4) of a fixing device (10). Japanese Unexamined Patent Application Publication No. 2008-292793 also describes a technology for correcting a lateral displacement of a pressure belt (2) by causing a belt regulating member (41) at the end of the pressure belt (2) to rotate about a protrusion (42).

Japanese Unexamined Patent Application Publication No. 08-286548 describes a structure in which separation members (14, 15) are provided to separate a recording sheet from fixing rollers (4, 5). The separation member (14) is rotatably supported by a link plate (21). The separation member (14) is elastically pushed against the fixing roller (4) by a spring. A paper output unit (13) including the separation member (14) is rotatable about a pivot (17). When the paper output unit (13) rotates about the pivot (17), the link plate (21) comes into contact with a separation member positioning stopper (18). Thus, the separation member (14) is positioned.

### SUMMARY

Aspects of non-limiting embodiments of the present disclosure relate to suppression of positional deviation of a separator relative to an endless belt-shaped transporter compared with a structure in which the separator is not positioned relative to the transporter or a structure in which a separation member is positioned near the body of a transport device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transport device comprising: an endless first transporter configured to transport a medium; a second transporter facing the first transporter, and configured to transport the medium while nipping the medium between the first transporter and the second transporter; a first support that supports the first transporter; a second support that supports the first support and is movable relative to the first support; and a separator supported by the second support, and configured to separate the medium from the first transporter.

### BRIEF DESCRIPTION OF THE DRAWINGS

An exemplary embodiment of the present disclosure will be described in detail based on the following figures, wherein:

FIG. 1 illustrates an overall image forming apparatus of an exemplary embodiment;

FIG. 2 is an enlarged view of a visible image forming device of the exemplary embodiment;

FIG. 3 is a sectional view of a fixing device of the exemplary embodiment;

FIGS. 4A and 4B are detailed perspective views of the fixing device of the exemplary embodiment, in which FIG. 4A is a perspective view of a heating belt part and FIG. 4B is a perspective view of a state in which an outer frame in FIG. 4A is removed; and

FIG. 5 is a sectional view taken along the line V-V in FIG. 4B.

### DETAILED DESCRIPTION

An exemplary embodiment of the present disclosure is described with reference to the drawings. The exemplary embodiment of the present disclosure is not limited to the following exemplary embodiment.

To facilitate understanding of the following description, the drawings illustrate a fore-and-aft direction as an X-axis direction, a lateral direction as a Y-axis direction, and a vertical direction as a Z-axis direction. In the drawings, directions or sides indicated by arrows X, −X, Y, −Y, Z, and −Z are defined as “forward”, “rearward”, “rightward”, “leftward”, “upward”, and “downward”, or “front side”, “rear side”, “right side”, “left side”, “upper side”, and “lower side”, respectively.

In the drawings, a symbol represented by a dot in a circle means an arrow from back to front on the drawing sheet, and a symbol represented by a letter “x” in a circle means an arrow from front to back on the drawing sheet.

In the following description with reference to the drawings, illustrations other than members necessary to facilitate understanding are omitted as appropriate.

### Exemplary Embodiment

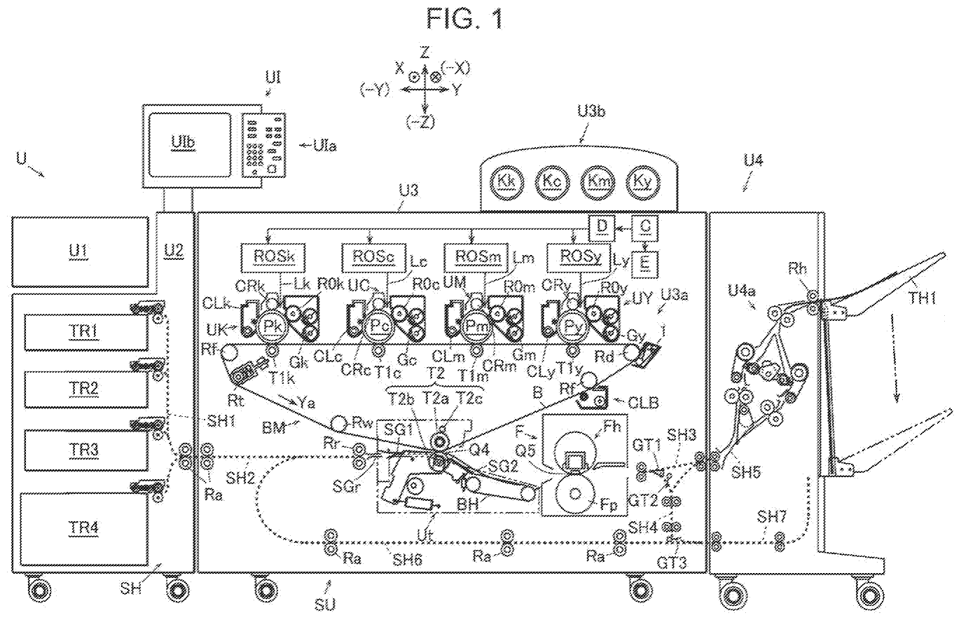

FIG. 1 illustrates an overall image forming apparatus of the exemplary embodiment.

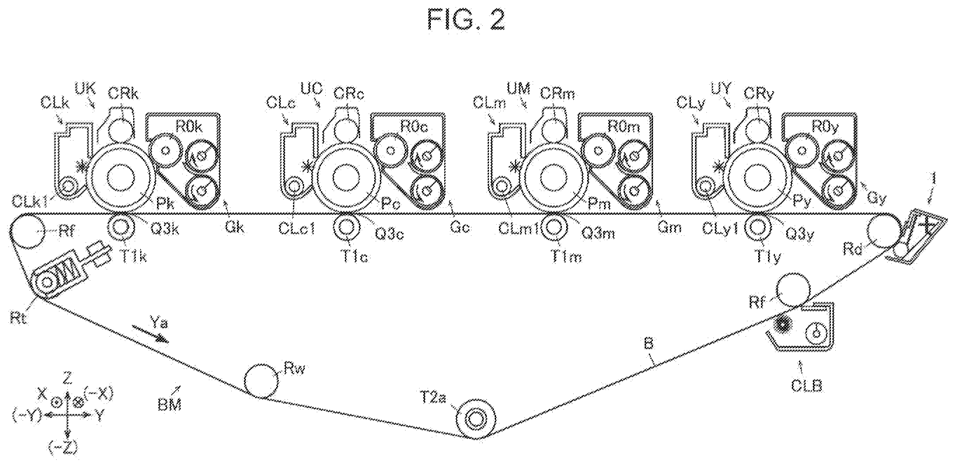

FIG. 2 is an enlarged view of a visible image forming device of the exemplary embodiment.

In FIG. 1, a copying machine U that is an example of the image forming apparatus includes a user interface UI that is an example of an operator, a scanner U1 that is an example of an image reading device, a feeder U2 that is an example of a medium feeding device, an image forming unit U3 that is an example of an image recording device, and a medium processing device U4.

### (User Interface UI)

The user interface UI includes input buttons UIa to be used for starting copying and setting the number of copies. The user interface UI further includes a display Ulb that displays information input by using the input buttons Ula and the status of the copying machine U.

### (Feeder U2)

In FIG. 1, the feeder U2 includes a plurality of paper feed trays TR1, TR2, TR3, and TR4 that are examples of a medium container. The feeder U2 further includes a medium feed path SH1 along which recording paper S that is an example of an image recording medium is picked out from any one of the paper feed trays TR1 to TR4 and transported to the image forming unit U3.

### (Image Forming Unit U3 and Medium Processing Device U4)

In FIG. 1, the image forming unit U3 includes an image recorder U3a that records an image on the recording paper S transported from the feeder U2 based on a document image read by the scanner U1.

In FIGS. 1 and 2, a latent image forming device driving circuit D of the image forming unit U3 outputs, based on image information input from the scanner U1, driving signals to yellow (Y), magenta (M), cyan (C), and black (K) latent image forming devices ROSy, ROSm, ROSc, and ROSk at preset timings. Photoconductor drums Py, Pm, Pc, and Pk that are examples of an image carrier are disposed below the latent image forming devices ROSy to ROSK that are examples of a writer, respectively.

The surfaces of the rotating photoconductor drums Py to Pk are uniformly charged by charging rollers CRy, CRm, CRc, and CRk that are examples of a charger, respectively. Electrostatic latent images are formed on the charged surfaces of the photoconductor drums Py to Pk by laser beams Ly, Lm, Lc, and Lk that are examples of latent image writing light and output from the latent image forming devices ROSy to ROSK, respectively. The electrostatic latent images on the surfaces of the photoconductor drums Py to Pk are developed into yellow (Y), magenta (M), cyan (C), and black (K) toner images that are examples of a visible image by developing devices Gy, Gm, Gc, and Gk that are examples of a developing unit, respectively.

In the developing devices Gy to Gk, developers consumed by development are supplied from toner cartridges Ky, Km, Kc, and Kk that are examples of a developer container, respectively. The toner cartridges Ky to Kk are removably mounted on a developer supply device U3b.

The toner images on the surfaces of the photoconductor drums Py to Pk are sequentially transferred and laid over one another in first transfer areas Q3y, Q3m, Q3c, and Q3k on an intermediate transfer belt B that is an example of an intermediate transferrer by first transfer rollers T1y, T1m, T1c, and T1k that are examples of a first transferrer, respectively. Thus, a color toner image that is an example of a multicolor visible image is formed on the intermediate transfer belt B. The color toner image formed on the intermediate transfer belt B is transported to a second transfer area Q4.

In a case of black image information alone, the black photoconductor drum Pk and the black developing device Gk are used to form a black toner image.

On the photoconductor drums Py to Pk after the first transfer, drum cleaners CLy, CLm, CLc, and CLk that are examples of an image carrier cleaner remove residues such as residual developers or paper dust on the surfaces, respectively.

In the exemplary embodiment, the photoconductor drum Pk, the charging roller CRk, and the drum cleaner CLk are integrated into a black photoconductor unit UK that is an example of an image carrier unit. In the other colors (yellow, magenta, and cyan) as well, the photoconductor drums Py, Pm, and Pc, the charging rollers CRy, CRm, and CRc, and the drum cleaners CLy, CLm, and CLc constitute photoconductor units UY, UM, and UC, respectively.

The black photoconductor unit UK and the developing device Gk including a developing roller ROK that is an example of a developer carrier constitute a black image former UK+Gk. Similarly, the yellow, magenta, and cyan photoconductor units UY, UM, and UC and the developing devices Gy, Gm, and Gc including developing rollers ROy, ROm, and ROc constitute yellow, magenta, and cyan image formers UY+Gy, UM+Gm, and UC+Gc, respectively.

A belt module BM that is an example of the intermediate transferrer is disposed below the photoconductor drums Py to Pk. The belt module BM includes the intermediate transfer belt B that is an example of the image carrier, a driving roller Rd that is an example of an intermediate transferrer driver, a tension roller Rt that is an example of a tensile force applier, a walking roller Rw that is an example of a meandering preventer, a plurality of idler rollers Rf that is examples of a driven component, a backup roller T2a that is an example of a facing component, and the first transfer rollers T1y to T1k. The intermediate transfer belt B is supported while being rotatable in an arrow Ya direction.

In the exemplary embodiment, the yellow, magenta, and cyan first transfer rollers T1y, T1m, and T1c are supported while being approachable to or separable from the photoconductor drums Py, Pm, and Pc, respectively. In multicolor printing, the yellow, magenta, and cyan first transfer rollers T1y to T1c approach the photoconductor drums Py to Pc, respectively, to nip the intermediate transfer belt B at a predetermined contact pressure. In monochrome printing using black alone, the first transfer rollers T1y to T1c are separated from the photoconductor drums Py to Pc, respectively.

A second transfer unit Ut is disposed below the backup roller T2a. The second transfer unit Ut includes a second transfer roller T2b that is an example of a second transferrer. The second transfer area Q4 is an area where the second transfer roller T2b is in contact with the intermediate transfer belt B. The backup roller T2a faces the second transfer roller T2b across the intermediate transfer belt B. A contact roller T2c that is an example of a power supplier is in contact with the backup roller T2a. A second transfer voltage having the same polarity as a toner charging polarity is applied to the contact roller T2c.

The backup roller T2a, the second transfer roller T2b, and the contact roller T2c constitute a second transferrer T2 that is an example of a transferrer.

The second transfer unit Ut of the exemplary embodiment is approachable to or separable from the intermediate transfer belt B. Depending on the type of the recording paper S in use, the second transfer unit Ut moves to change the contact pressure between the second transfer roller T2b and the intermediate transfer belt B. For example, in a case of thick paper, the contact pressure is reduced compared with a case of plain paper to reduce an impact when the leading edge of the thick paper enters the second transfer area Q4.

A medium transport path SH2 is disposed below the belt module BM. The recording paper S fed through the medium feed path SH1 of the feeder U2 is transported to registration rollers Rr that are an example of a transport timing adjuster by transport rollers Ra that are an example of a medium transporter. The registration rollers Rr transport the recording paper S downstream in synchronization with a timing when the toner image formed on the intermediate transfer belt B is transported to the second transfer area Q4. The recording paper S sent out by the registration rollers Rr is guided by a registration paper guide SGr and a pre-transfer paper guide SG1 and transported to the second transfer area Q4.

The toner image on the intermediate transfer belt B is transferred onto the recording paper S by the second transferrer T2 when passing through the second transfer area Q4. In the case of a color toner image, the toner images firstly transferred onto the surface of the intermediate transfer belt B and laid over one another are secondly transferred collectively onto the recording paper S.

The first transfer rollers T1y to T1k, the second transferrer T2, and the intermediate transfer belt B constitute a transfer device (transferrer) T1y−T1k+T2+B of the exemplary embodiment.

The intermediate transfer belt B after the second transfer is cleaned by a belt cleaner CLB that is an example of an intermediate transferrer cleaner disposed on a downstream side of the second transfer area Q4. The belt cleaner CLB removes, from the intermediate transfer belt B, residues such as paper dust or developers that remain without being transferred in the second transfer area Q4.

The recording paper S onto which the toner image is transferred is guided by a post-transfer paper guide SG2 and sent to a belt transport device BH that is an example of the medium transporter. The belt transport device BH transports the recording paper S to a fixing device F that is an example of a transporter.

The fixing device F includes a heating belt Fh that is an example of a heating fixer, and a pressure roller Fp that is an example of a pressurizing fixer. The recording paper S is transported to a fixing area Q5 where the heating belt Fh is in contact with the pressure roller Fp. The toner image on the recording paper S is fixed by being heated and pressurized by the fixing device F when passing through the fixing area Q5.

The image formers UY+Gy to UK+Gk, the transfer device T1y−T1k+T2+B, and the fixing device F constitute the image recorder U3a that is an example of an image former of the exemplary embodiment.

A switching gate GT1 that is an example of a switcher is provided on a downstream side of the fixing device F. The switching gate GT1 selectively switches the recording paper S having passed through the fixing area Q5 into an output path SH3 toward the medium processing device U4 or into a reversing path SH4. The recording paper S transported to the output path SH3 is transported to a paper transport path SH5 of the medium processing device U4. A curl correction member U4a that is an example of a warp corrector is disposed on the paper transport path SH5. The curl correction member U4a corrects a warp, that is, a curl of the transported recording paper S. The recording paper S having undergone the curl correction is output, with its image-fixed side oriented upward, to an output tray TH1 that is an example of a medium outputter by output rollers Rh that are an example of a medium output member.

The recording paper S transported toward the reversing path SH4 of the image forming unit U3 by the switching gate GT1 is transported to the reversing path SH4 of the image forming unit U3 through a second gate GT2 that is an example of the switcher.

To output the recording paper S with its image-fixed side oriented downward, the transport direction of the recording paper S is reversed after the trailing edge of the recording paper S in the transport direction has passed through the second gate GT2. The second gate GT2 of the exemplary embodiment is a thin-film elastic member. The second gate GT2 causes the recording paper S to temporarily pass when it is transported toward the reversing path SH4, and guides the recording paper S toward the transport paths SH3 and SH5 when the recording paper S is reversed, that is, switched back. The switched-back recording paper S is output to the output tray TH1 through the curl correction member U4a with its image-fixed side oriented downward.

A circulation path SH6 is connected to the reversing path SH4 of the image forming unit U3. A third gate GT3 that is an example of the switcher is disposed at the connecting portion. The downstream end of the reversing path SH4 is connected to a reversing path SH7 of the medium processing device U4.

The recording paper S transported to the reversing path SH4 through the switching gate GT1 is transported toward the reversing path SH7 of the medium processing device U4 by the third gate GT3. The third gate GT3 of the exemplary embodiment is a thin-film elastic member similarly to the second gate GT2. The third gate GT3 causes the recording paper S to temporarily pass when it is transported along the reversing path SH4, and guides the recording paper S toward the circulation path SH6 when the recording paper S is switched back.

The recording paper S transported to the circulation path SH6 is sent again to the second transfer area Q4 through the medium transport path SH2, and printing is performed on the second side.

The elements SH1 to SH7 constitute a paper transport path SH. The elements SH, Ra, Rr, Rh, SGr, SG1, SG2, BH, and GT1 to GT3 constitute a paper transport device SU of the exemplary embodiment.

### (Fixing Device)

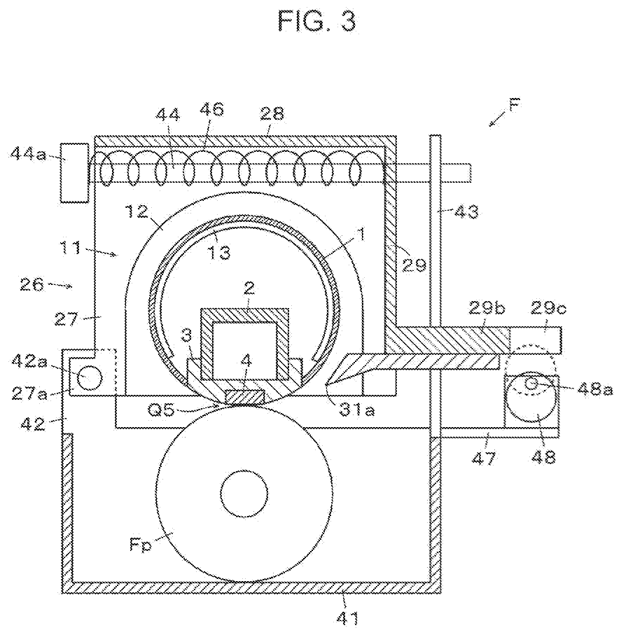

FIG. 3 is a sectional view of the fixing device of the exemplary embodiment.

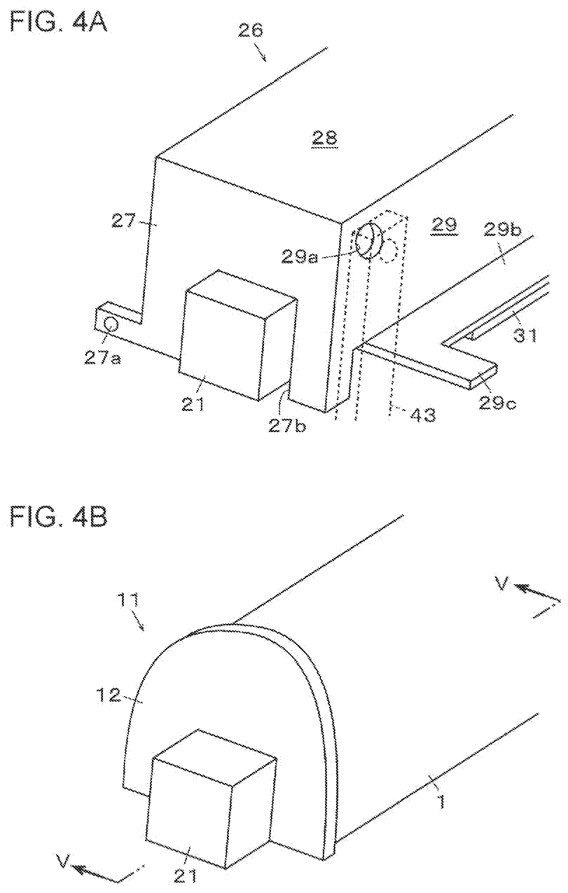

FIGS. 4A and 4B are detailed perspective views of the fixing device of the exemplary embodiment. FIG. 4A is a perspective view of a heating belt part. FIG. 4B is a perspective view of a state in which an outer frame in FIG. 4A is removed.

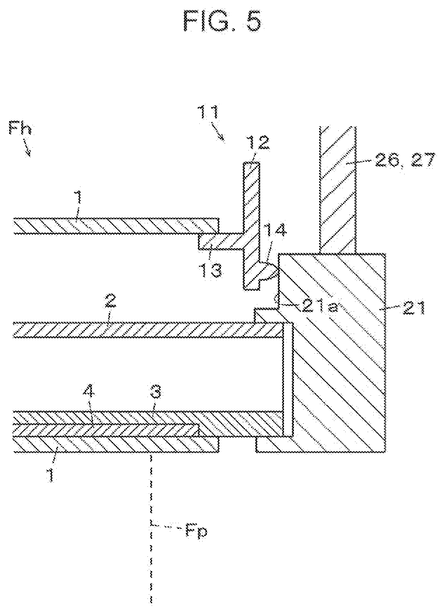

FIG. 5 is a sectional view taken along the line V-V in FIG. 4B.

In FIGS. 3 to 5, the fixing device F that is an example of a fixer and the transporter includes the heating belt Fh that is an example of a first transporter, and the pressure roller Fp that is an example of a second transporter.

The heating belt Fh has a belt body 1 that is an example of the body of the first transporter. The belt body 1 has an endless belt shape. An internal frame 2 that is an example of an internal support is disposed in the belt body 1. The internal frame 2 extends along a width direction of the belt body 1, and has an inverted U-shape in cross section. A resistor support 3 that is an example of a heating support is supported on the internal frame 2 near the fixing area Q5.

A heating resistor 4 that is an example of a heater is supported on the resistor support 3 near the fixing area Q5. In the fixing area Q5, the heating resistor 4 faces the pressure roller Fp across the belt body 1. The heating resistor 4 generates heat when energized. The fixing temperature in the fixing area Q5 may be controlled by controlling ON and OFF of heat generation of the heating resistor 4.

In FIGS. 3, 4A, and 5, belt guides 11 that are examples of a guide are disposed at both ends of the belt body 1 of the exemplary embodiment. The belt guide 11 has a plate 12 as an example of its body. The plate 12 has an arc shape along the circumferential direction of the belt body 1. The outer end of the belt body 1 may come into contact with the plate 12 when the belt body 1 moves in a belt width direction.

The plate 12 has a guide portion 13. The guide portion 13 has a rib shape to protrude inward from an inner surface in the width direction of the belt body 1. As illustrated in FIG. 3, the guide portion 13 guides the rotating belt body 1 in a predetermined posture. The plate 12 has a swing protrusion 14 that is an example of a swing pivot. The swing protrusion 14 protrudes outward from an outer surface in the width direction of the belt body 1.

First fixing frames 21 that are examples of a first support are supported at both ends of the internal frame 2 and the resistor support 3 in a longitudinal direction (width direction of the belt body 1). In FIG. 5, the first fixing frame 21 has a support surface 21a that faces the swing protrusion 14. The belt guide 11 is supported by the first fixing frame 21 and swingable about the distal end of the swing protrusion 14. When the outer end of the belt body 1 comes into contact with the plate 12 and pushes the plate 12 in the belt width direction because the belt body 1 moves in the belt width direction, that is, the belt body 1 is laterally displaced or meanders, the belt guide 11 swings and tilts about the swing protrusion 14. Along with the tilt, the tensile force of the belt body 1 and the position corresponding to the rotational center of the belt body 1 change and the belt body 1 moves in a direction in which the lateral displacement of the belt body 1 is corrected. Thus, the lateral displacement or meander of the belt body 1 is corrected by the belt guide 11 that is an example of a lateral displacement corrector.

The swing protrusions 14 and the support surfaces 21a may be provided on both sides in the belt width direction. Alternatively, the belt body 1 may be designed, for example, to be laterally displaced in one specific direction of the belt width direction, and the swing protrusion 14 etc. may be provided on the side where the belt body 1 is laterally displaced but not on the other side.

A second fixing frame 26 that is an example of a second support is supported on the outer side of the belt body 1. The second fixing frame 26 has a pair of side plates 27 disposed at both ends in the belt width direction. The side plate 27 has a rotational center portion 27a at the upstream end in the paper transport direction. The side plate 27 has an opening portion 27b that supports the first fixing frame 21. The opening portion 27b supports the first fixing frame 21 so that the first fixing frame 21 is movable along the vertical direction, that is, the heating belt Fh is approachable to or separable from the pressure roller Fp.

The second fixing frame 26 has a top plate 28 and a downstream plate 29 that couple the pair of side plates 27. The downstream plate 29 has bolt through holes 29a that are examples of a push-target portion at both ends in the belt width direction. The downstream plate 29 has a separation support 29b formed along the belt width direction and extending downstream in the paper transport direction. A release-target portion 29c is formed at the outer end of the separation support 29b in the belt width direction.

A separation claw 31 that is an example of a separator is supported by the separation support 29b. The separation claw 31 is disposed so that a distal end 31a is positioned close to the belt body 1 with a predetermined clearance on the downstream side of the fixing area Q5 in the paper transport direction.

The pressure roller Fp is rotatably supported by a third fixing frame 41 that is an example of a third support. The third fixing frame 41 has a rotation support 42 at a position corresponding to the rotational center portion 27a. The rotation support 42 rotatably supports the second fixing frame 26 by a rotational shaft 42a.

The third fixing frame 41 has a bolt support 43 that is an example of a push support and extends toward the bolt through hole 29a. A bolt 44 is supported by the bolt support 43. The bolt 44 extends through the bolt through holes 29a. A spring 46 that is an example of a pusher is attached between a head 44a of the bolt 44 and the outer edge of the bolt through hole 29a. The spring 46 applies an elastic force for pushing the outer edge of the bolt through hole 29a. Therefore, the second fixing frame 26 is pushed clockwise in FIG. 3 about the rotational shaft 42a. Thus, the first fixing frames 21 and the belt body 1 supported by the second fixing frame 26 are pushed toward the pressure roller Fp. Accordingly, a predetermined fixing pressure is applied in the fixing area Q5 to pressurize the recording paper S passing through the fixing area Q5.

The first fixing frame 21 is positioned in the lateral direction though it is movable in the vertical direction relative to the second fixing frame 26. While the fixing pressure is applied, the belt body 1 is positioned also in the vertical direction in which it faces the pressure roller Fp.

The third fixing frame 41 has a release support 47 that faces the release-target portion 29c. A switching cam 48 that is an example of a switcher is supported by the release support 47 and is rotatable about a rotational center 48a. The switching cam 48 is a so-called eccentric cam. The switching cam 48 is rotatable between a push position indicated by the solid line in FIG. 3 and a release position indicated by the broken line in FIG. 3. At the release position, the switching cam 48 comes into contact with the release-target portion 29c. Therefore, the second fixing frame 26 moves upward about the rotational shaft 42a against the pushing force of the spring 46. Thus, the heating belt Fh is released from the pressure roller Fp. Accordingly, the contact pressure (fixing pressure) between the heating belt Fh and the pressure roller Fp decreases.

At the push position, the switching cam 48 is separated from the release-target portion 29c. Therefore, the heating belt Fh is pushed against the pressure roller Fp at the fixing pressure described above with the force of the spring 46. The switching cam 48 may be operated manually with a knob (not illustrated) or controlled automatically with a motor etc.

### OPERATIONS OF EXEMPLARY EMBODIMENT

In the fixing device F of the exemplary embodiment structured as described above, the third fixing frame 41 that supports the pressure roller Fp is supported by the copying machine U, and the second fixing frame 26 is supported to be rotatable relative to the third fixing frame 41. In the exemplary embodiment, the first fixing frames 21 that support the heating belt Fh are supported by the second fixing frame 26 to be movable in the direction in which the first fixing frames 21 are pushed toward the pressure roller Fp.

In the related art described in Japanese Unexamined Patent Application Publication No. 2020-134885, the end of the support member (108b) abuts against the fixing flange (104) at the end in the belt width direction of the fixing belt (101) so that the separation sheet (108) is positioned relative to the fixing belt (101). The fixing flange (104) described in Japanese Unexamined Patent Application Publication No. 2020-134885 is a member corresponding to the belt guide 11 of the exemplary embodiment. In the structure in which the fixing flange (104) is a fixed member, that is, the swing protrusion 14 is not provided, lateral displacement or meander of the fixing belt (101) is not prevented. In other words, in the structure in which the fixing flange (104) including the separation sheet (108) is positioned on the fixed frame side of the body of the fixing device (example of the transport device), the lateral displacement etc. of the fixing belt (101) is not addressed. Thus, the lateral displacement or meander of the fixing belt (101) may occur to cause fixing failure, breakage of the fixing belt (101), etc.

If the fixing flange (104) is swingable in the structure of Japanese Unexamined Patent Application Publication No. 2020-134885, the separation sheet (108) positioned on the fixing flange (104) swings as well. That is, the separation sheet (108) is not positioned. In this case, the position of the separation sheet (108) is likely to deviate relative to the fixing belt (101). That is, the distance between the fixing belt (101) and the separation sheet (108) is not stable. Thus, separation failure may occur.

In the related art described in Japanese Unexamined Patent Application Publication No. 2008-292793, the separation guide (4) is not provided for the endless pressure belt (2), and there is no description about a structure for keeping the distance between the belt and the separator. Japanese Unexamined Patent Application Publication No. 08-286548 describes the separation member (14) for the fixing roller (4, 5), but there is no description about the structure for keeping the distance between the belt and the separator.

In the fixing device F of the exemplary embodiment, the belt body 1 is supported by the first fixing frames 21 via the internal frame 2 and the resistor support 3. The first fixing frames 21 are supported by the second fixing frame 26, and the separation claw 31 is fixed to and supported by the second fixing frame 26. While the fixing pressure is applied, the first fixing frames 21 and the belt body 1 are positioned by being pushed by the second fixing frame 26.

In the fixing device F serving as the transport device of the exemplary embodiment, the recording paper S may stick to the heating belt Fh due to melting of the developer during heating. The separation claw 31 of the exemplary embodiment whose positional deviation is suppressed stably separates the recording paper S.

When application and release of the fixing pressure are switched by the switching cam 48, the heating belt Fh moves relative to the pressure roller Fp. In the exemplary embodiment, the positions of the heating belt Fh and the separation claw 31 are stable while the fixing pressure is applied, even though the heating belt Fh moves when the fixing pressure is released.

### Modifications

Modifications (H01) to (H08) of the exemplary embodiment of the present disclosure are described below.

(H01) In the exemplary embodiment, the copying machine U is provided as the example of the image forming apparatus. The image forming apparatus may be a FAX machine or a multifunction peripheral having a plurality of functions of a FAX machine, a printer, and a copying machine. The image forming apparatus is not limited to the multicolor-development image forming apparatus, and may be a monochrome image forming apparatus. Further, any electronic or mechanical apparatus using motors and gears may be an alternative to the image forming apparatus.

(H02) In the exemplary embodiment, the fixing device F is provided as the example of the transport device. For example, the transport device may include a transfer roller (example of a transferrer) on the inner side of a transfer and transport belt to transfer an image from the photoconductor, and transport the recording paper S while nipping it between the photoconductor and the transfer and transport belt. Alternatively, the transport device may transport the recording paper S while nipping it between the second transfer roller T2b and the intermediate transfer belt B that is an example of the transferrer and has the backup roller T2a disposed on the inner side.

(H03) In the exemplary embodiment, the switching cam 48 that releases the fixing pressure may be omitted.

(H04) In the exemplary embodiment, the belt guide 11 suppresses lateral displacement or meander, but may have a shock absorption and cushioning function alone to suppress breakage of the end of the belt body 1.

(H05) In the exemplary embodiment, the belt guide 11 has a so-called passive structure in which the lateral displacement correcting function is exerted when the belt body 1 is laterally displaced and comes into contact with the belt guide 11. For example, the belt guide 11 may have a so-called active structure in which the lateral displacement of the belt body 1 is detected by a sensor etc. and corrected by tilting the belt guide 11 with a motor etc.

(H06) In the exemplary embodiment, the separation claw 31 is provided as the separator. The separator may have any shape such as a sheet shape, a plate shape, a block shape, or a finger shape.

(H07) In the exemplary embodiment, the separator may be positionally adjustable relative to the belt body 1 when assembled.

(H08) In the exemplary embodiment, the separator may be integrated with the second fixing frame 26.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A transport device comprising:
an endless first transporter configured to transport a medium;
a second transporter facing the first transporter, and configured to transport the medium while nipping the medium between the first transporter and the second transporter;
a first support that supports the first transporter;
a second support that supports the first support and is movable relative to the first support; and
a separator supported by the second support, and configured to separate the medium from the first transporter.
   (((2)))

The transport device according to (((1))), further comprising a heater disposed inside the first transporter, and configured to generate heat for fixing an unfixed developer on a surface of the medium.

(((3)))

The transport device according to (((1))) or (((2))), further comprising a transferrer disposed inside the first transporter, and configured to apply a transfer voltage for transferring an image onto the medium.

(((4)))

The transport device according to any one of (((1))) to (((3))), wherein the first support supports both ends of the first transporter in a width direction.

(((5)))

The transport device according to any one of (((1))) to (((4))), further comprising a guide disposed at least at one end in a width direction of the first transporter, and configured to guide the first transporter by coming into contact with the first transporter in response to movement of the first transporter in the width direction.

(((6)))

The transport device according to (((5))), wherein the guide is configured to guide the first transporter in contact to an opposite side in the width direction to correct lateral displacement of the first transporter.

(((7)))

The transport device according to any one of (((1))) to (((6))), further comprising a pusher supported by the second support, and configured to push the first transporter toward the second transporter.

(((8)))

The transport device according to (((7))), further comprising a switcher configured to switch push and release of the first transporter relative to the second transporter by the pusher.

(((9)))

An image forming apparatus comprising:
an image former configured to form an image; and
the transport device according to any one of (((1))) to (((8))) configured to transport a medium that carries the image formed by the image former.

What is claimed is:

1. A transport device comprising:
an endless first transporter configured to transport a medium;
a second transporter facing the first transporter, and configured to transport the medium while nipping the medium between the first transporter and the second transporter;
a first support that supports the first transporter;
a second support that supports the first support and is movable relative to the first support; and
a separator supported by the second support, and configured to separate the medium from the first transporter.

2. The transport device according to claim 1, further comprising a heater disposed inside the first transporter, and configured to generate heat for fixing an unfixed developer on a surface of the medium.

3. The transport device according to claim 1, further comprising a transferrer disposed inside the first transporter, and configured to apply a transfer voltage for transferring an image onto the medium.

4. The transport device according to claim 1, wherein the first support supports both ends of the first transporter in a width direction.

5. The transport device according to claim 1, further comprising a guide disposed at least at one end in a width direction of the first transporter, and configured to guide the first transporter by coming into contact with the first transporter in response to movement of the first transporter in the width direction.

6. The transport device according to claim 5, wherein the guide is configured to guide the first transporter in contact to an opposite side in the width direction to correct lateral displacement of the first transporter.

7. The transport device according to claim 1, further comprising a pusher supported by the second support, and configured to push the first transporter toward the second transporter.

8. The transport device according to claim 7, further comprising a switcher configured to switch push and release of the first transporter relative to the second transporter by the pusher.

9. An image forming apparatus comprising:
an image former configured to form an image; and
the transport device according to claim 1 configured to transport a medium that carries the image formed by the image former.

10. An image forming apparatus comprising:
an image former configured to form an image; and
the transport device according to claim 2 configured to transport a medium that carries the image formed by the image former.

11. An image forming apparatus comprising:
an image former configured to form an image; and
the transport device according to claim 3 configured to transport a medium that carries the image formed by the image former.

12. An image forming apparatus comprising:
an image former configured to form an image; and
the transport device according to claim 4 configured to transport a medium that carries the image formed by the image former.

13. An image forming apparatus comprising:
an image former configured to form an image; and
the transport device according to claim 5 configured to transport a medium that carries the image formed by the image former.

14. An image forming apparatus comprising:
an image former configured to form an image; and
the transport device according to claim 6 configured to transport a medium that carries the image formed by the image former.

15. An image forming apparatus comprising:
an image former configured to form an image; and
the transport device according to claim 7 configured to transport a medium that carries the image formed by the image former.

16. An image forming apparatus comprising:
an image former configured to form an image; and
the transport device according to claim 8 configured to transport a medium that carries the image formed by the image former.

17. A transport device comprising:
endless first transport means for transporting a medium;
second transport means for transporting the medium while nipping the medium between the first transport means and the second transport means, the second transport means facing the first transport means;
first support means for supporting the first transport means;
second support means for supporting the first support means, the second support means being movable relative to the first support means; and
separation means for separating the medium from the first transport means, the separation means being supported by the second support means.
